(19) United States
(12) Patent Application Publication
(10) Pub. No.: US 2006/0193133 A1
(43) Pub. Date: Aug. 31, 2006

(54) Lamp

(75) Inventor: Jens Von Der Brelie, Frankfurt (DE)

Correspondence Address: THE FIRM OF KARL F ROSS, 5676 RIVERDALE AVENUE, PO BOX 900, RIVERDALE (BRONX), NY, 10471-0900, US

(73) Assignee: ERCO Leuchten GmbH

(21) Appl. No.: 11/189,104

(22) Filed: Jul. 25, 2005

(30) Foreign Application Priority Data
Feb. 25, 2005 (DE) 202005003285.9
Feb. 25, 2005 (DE) 102005009228.4
May 24, 2005 (DE) 102005024449.1

(51) Int. Cl. F21V 23/04

(52) U.S. Cl. 362/276

(57) ABSTRACT

A lamp, luminaire, lamp system or the like containing at least one light source which is associated with a memory individual thereto and in which a data set is recorded that describes at least one characteristic of this light source, preferably the color value or spectrum or the maximum light current or lumen output or a temperature dependency or aging dependency thereof.

### CROSS REFERENCE TO RELATED APPLICATION

This application is related to the commonly owned copending application Ser. No. 11/091,356 filed 23 Mar. 2005 and German application 10 2005009228.4 filed 25 Feb. 2005, the contents of which are hereby incorporated by reference and to German applications 10 2005024 449.1 of 24 May 2005 and 20 2005003285.9 of 25 Feb. 2005 under the International Convention.

### FIELD OF THE INVENTION

My present invention relates to lamps and lamp systems and to a method of operating a lamp (luminaire) or lamp system. More particularly, the invention relates to a lamp having at least one light source which is addressable over a signal line, to lamp systems including such lamps, to a network or arrangement for addressing the light source thereof, and to a method of operating same.

### BACKGROUND OF THE INVENTION

Lamps having at least one light source which can be addressed for individual control through a signal line are widely used and have been made for a decade by the assignee of this application.

The invention is especially concerned with such lamps which can be used as interior lighting, exterior lighting, for accent lighting or object illumination, for landscape lighting and building and structure lighting and for the illumination of surfaces, ground areas or specific objects or regions, including orientable lighting and decorative lighting. The invention also can be said to relate to such lamps which upon manufacture, that is at the factory, can have at least one light source fitted to the lamp.

The term “light source” is here used to refer to the part of a lamp which actually produces the light. As the discussion below will show, that source more often than not will be one or more light-emitting diodes (LEDs), although the term light source as used here will encompass all other light generating elements and types as well. These include incandescent, fluorescent, discharge, glow, halogen and like light sources.

From German Patent Document DE 19 817 0731 of the assignee of the present application, it is already known to assemble a multiplicity of lamps to a lamp network.

This system, comprises a multiplicity of individually controllable lamps, which has a control unit which can individually address the lamps and transmit control signals or control information over a separate signal transmission line to them. In the state of the art represented by this system, each lamp has an individual light source and control information which is transmitted over the signal line to this light source will generally be information which can switch it on or off, can dim it or can cause it to flash or blink or the like. For the case in which the lamp may have a number of light sources of different colors, the control information can also be such as to effect a color change in the illumination produced by the lamp so that the illumination is a mixed color illumination.

To the extent that the present invention also relates to a lamp which is connectable in system or network of individually controllable lamps and which such other lamps can be controlled by one or more controllers or control units through signal lines, the invention is also deemed to apply to such systems.

Although not exclusively, the lamps of the invention may be connected in a network operating in accordance with the DALI protocol. DALI (Digital Addressable Lighting Interface) is a signal connections protocol that has been accepted by companies in the DALI association, namely, the Central Federation of The Electrotechnique Industry and Electronics Industry (ZVEI).

In the published handbook DALI (AG DALI an activity of the industry community of ZVEI”, Richard Pflaum Publishers, Munich, Germany), a system for controlling a multiplicity of lamps has been set forth in which each lamp has a respective DALI electronic control gear (switching unit) or operating unit or device which has a memory into which address data and light scene information can be inscribed or registered. The lamps assembled in a DALI network are connected with the common controller via the signal connection line.

Mention may also be made of the lamps described in the above-identified copending application in that context.

For the case in which a number of lamps are provided directly adjoining one another in the same space to be illuminated, i.e. next to one another, and serve to illuminate for example the same surface or directly neighboring surfaces, it is important to be able to control the colors, brightness and like parameters of the individual lights and thus their light colors, so that they will be matched. When, for example, a wall having a length of a number of meters is to be flood-lighted by a number of lamps, color differences and even brightness differences in the lamps immediately are noticed. Furthermore, different lamps or different light sources can have variations in fabrication, for example with respect to maximum possible light currents (maximum lumen outputs), the colors produced, aging and temperature dependent color and brightness differences and the like. Such problems arise especially when a lamp may have a number of light sources with different colors and is intended to produce a mixed color output.

### OBJECTS OF THE INVENTION

It is, therefore, the principal object of the present invention to provide an improved lamp or luminaires which can avoid the drawbacks outlined above and the prior art.

Another object of this invention is to provide a light source which is free from these drawbacks.

It is also an object of the invention to provide a lighting system consisting of at least one lamp with at least one light source and at least one control line connecting the lamp or lamps with at least one controller, whereby disadvantages of earlier systems of that type are avoided.

Another object of the invention is to provide an improved method of operating a lamp, light source for a lamp, lamp system or lamp network so that better control of lighting effects can be obtained.

It is also an object of this invention to extend principles set forth originally in the above-identified copending application.

### SUMMARY OF THE INVENTION

These objects and others which will become apparent hereinafter are attained, in accordance with the invention by providing the lamp with a memory or data storage into which a data set can be inscribed or in which a data set can be stored and which describes at least one characteristic of a light source of the lamp. In accordance with the principles of the invention, therefore, the lamp or a lamp of a lamp network or illuminating system will include a memory in which a data set can be recorded or registered, where that data set describes at least one characteristic of the light source of the lamp. The characteristic which is stored can, for example, be a maximum current of this light source (maximum lumen output). Especially when the light source is comprised of one or more LEDs it is found that manufacture of the LEDs even to the best quality standards and with the most effective presorting may result in a variation between 70% and 100% of their maximum possible current for the LEDs received from the manufacturer. The maximum possible light current is usually determined by the wafer quality. This means that a first LED fabricated in a series can be operated at 100% of a light current maximum while a second LED may be operated only at 70% of maximum light current within the lot size. Should these two LEDs be installed in two different lamps to generate the same colors therein a light with the first LED at maximum supply current would be significantly brighter in that color than the lamp of the other LED. Mixed color lighting would reflect the maximum light current which can be produced by the respective light sources.

In accordance with the invention the characteristic of the light source which is stored in memory, for example the maximum light current or lumen output which can be obtained with the particular light source, is especially a measured value of the maximum possible light current of this light source. The measured value can be stored directly or as information associated with or representing that light current in a memory of the lamp as the data set or part of this data set. This data set can then be considered during the later control of the lamp so that when both lamps with the two LEDs receive a control signal indicating maximum brightness, the LED with the higher maximum light current will only be illuminated with 70% of the maximum current while the lamp has LED which can generate only 70% will be supplied with 100% of its capacity and therefore produce a maximum light output.

In this manner both lamps can generate the same brightness from the respective light sources so that the surface or region will be illuminated uniformly. The data set also enables consideration of the stored characteristic and especially a measured value of the stored characteristic associated with the particular light source for effecting a correction in the operation of the respective lamps.

The data set is preferably registered or inscribed in memory upon manufacture of the lamp, i.e. upon installation of the light source in the lamp, i.e. a factory data set. This can be achieved for example directly following the measurement of the maximum light current or for example when the light source is mounted in the lamp. The memory can for example be a separate electric element connected upstream of the lamp in for example a switching device or electronic control gear or unit, the latter receiving the control signals from a signal line and serving as kind of a repeater which can transmit the control signal to an electronic control unit of the light source or the light source directly.

The correction based upon the stored characteristic of the light source can then be made automatically.

Alternatively, the memory can be read out with a signal line connected to the memory whereby the control subsequent to read out of the characteristic of the respective light source can be based upon the read out information in the controller or some other circuitry effecting or receiving the readout.

In that case, the memory can be the memory provided in the electronic control unit or electronic control gear of the lamp like, for example, a light scene memory of a DALI electronic control gear.

Similarly, just as LEDs can have different maximum light currents, LEDs can also vary as to their color and can have wavelength differences for example of ±5 nm. These parameters also can be determined by measurement and stored in the memory as characteristics of the light sources in the form of a data set or as information contained in a data set. Especially when a multiplicity of light sources of different colors are provided, the exact light color which is produced by a particular light source can be registered in memory so that an optimum color mixing can result upon energization of the light sources and correction of the energization based upon the stored measurements of the exact color or frequency or wavelength of the particular light source. The result is an intelligent control based upon correction utilizing the stored information so that identical or controlled color emissions are ensured for the several light sources.

The data set registered in the memory can then include, in addition to the information previously described, information as to the exact light color produced by the light source. Instead of information that the LED produces a red color or is of a red color, the exact wavelength in the red region assigned to the particular LED, especially the location of the maximum of the emission spectrum of the LED when the LED is incorporated in the lamp, can be registered in the memory. The information can be the measured light color for the particular diode.

Apart from the exact light color in this sense it is possible to register in the memory also a spectral light distribution of the light source as part of the data set. The exact spectrum of the light source can also be measured at the time of manufacture and has been found especially by LEDs to differ from light source to light source.

Thus, according to the invention, characteristics of each light source, including information as to a maximum light current and/or information as to the exact light color can be stored as well as such parameters like a temperature-dependent property of the light source and/or an aging property of the light source. Both properties can be those of the maximum permitted light current (lumen output) as well as of the spectral variation. These characteristics not only play a role with LEDs but also with other light sources, for example, with OLEDs or even fluorescent or phosphorescent lamps. The invention is therefore applicable for light sources of all types and to lamps containing light sources of all types.

The temperature dependency of the light source may reflect variations in ambient temperature or differences in chip temperatures especially when LEDs are the light sources since the chip temperature is also a function of the duration during which an LED is energized. It is possible, according to the invention to provide a sensor in the lamp which can measure a temperature for example, the ambient temperature or a chip temperature and particularly a temperature which affects the operation of the light source. The information from the sensor is used in conjunction with the stored information in memory as to the temperature dependent property of the lamp to provide a corresponding correction or match of the control information supplied by the signal line, especially in the manner described to match the light current which is sent out or match a color mixing.

For the case in which the data set contains information as to an aging dependency property of the light source it has been found to be advantageous to associate with the memory and the lamp a device or unit which detects the operating duration of the lamp. This can be for example a kind of operation duration counter or hour counter which can in the case of LEDs as light sources, not only register the “on time” but also the current supply to the LED precisely over the duration of operation so that the work contributed by the LED can be detected by the circuitry directly.

From the information as to the total operating duration of the light source and the age dependent properties of the light source which can result in an effect upon the spectrum or cause a spectrum shift or change in the maximum light current, a corresponding correction or matching can be effected.

When the lamp, through its memory, contains information as to an aging dependent property of the light source it can be advantageous, further, to control the light source by automatically taking into consideration the maximum permissible operating temperature or, for example, in the case of LEDs, their maximum permissible operating current.

With these additional contributions to control of the color mixing and to the overall light distribution, the control unit can automatically limit the maximum permissible operating temperature or current automatically and thereby increase the life of the light source.

According to a method aspect of the invention, a method of operating a luminaire can comprise the steps of:

(a) providing at least one light source in a lamp housing,

(b) at a time of manufacture storing in a memory assigned to the light source at least one data set including information specific to the light source, the information comprising at least one item selected from the group which consists of:

an exact color value of the light source,

a maximum light current of the light source,

an aging-dependent property of the light source,

a temperature-dependent property of the light source, the wave length of the light source, and

a spectrum of the light source;

(c) downloading the data set to a controller; and

(d) addressing the light source selectively through a control line connected to the lamp with signals corrected with reference to the data set downloaded from said memory.

According to a feature of the invention, the memory and controller are provided in a relationship to the lamp which is selected from:

i) the memory and the controller are both located in the lamp;

ii) the memory is located in the lamp and the controller is located in a central control system connected to the lamp by the line; and

iii) the memory is a data carrier separable from the lamp and marketed therewith and the controller is located in a central control system connected to the lamp by the line or is in the lamp.

Preferably the lamp is connected by the signal line with a controller. One or more controllers can be used to control the lamp according to the invention. The controller or controllers can communicate with the lamp or lamps, according to a preferred feature of the invention, with control signals using the DALI protocol, thereby relying upon a widely used standard.

The lamps can have a memory which contains one data set or a memory or data storage in which a plurality of data sets are registered or recorded, or a plurality of memories or data storage units in which a plurality of data sets are recorded. The memories or each memory can contain one or more data sets which include one or more characteristics of one or more lamps. These characteristics, which are individual to the lamp, can include preferably:

an exact color value of the light source thereof,

a maximum light current of the light source thereof,

an aging-dependent property of the light source thereof,

a temperature-dependent property of the light source thereof,

the wavelength of the light source thereof, and

the spectrum of the light source thereof.

Preferably the lamps each have an operating or switching device accessible by the controller or the controllers, especially a DALI electronic control gear (ECG). As a result, known components can be used in carrying out the invention.

In accordance with a first aspect of the invention, the memory or data storage is located in the operating device (ECG) and is installed with the operating device (ECG) in the lamp. Thus the memory can be the light-scene memory already provided in a DALI electronic control gear (ECG) with which the lamp or luminaire may be equipped. According to the invention, this memory is provided at the factory or at the time of manufacture or assembly of the luminaire with the data set or data sets describing one or more of the aforementioned characteristics individual to the light source or lights sources of the luminaire.

In a particularly advantageous embodiment of the invention, the data set registered in the operating device can be read out over the signal line by the controller. Even when the memory or data storage is not located in the operating device (e.g., the DALI ECG), but rather is provided in a separate electronic component, the memory should be able to be read out by the controller and its data set delivered via the signal line to the controller or another target component for processing. As a general matter the data set can be recognized by and processed by the controller.

The controller or controllers can, depending upon the contents of the data set, transmit control signals to the luminaire based upon the characteristics of the light source or light sources thereof. This means that the controller transmits control information to the luminaire or lamp, especially to the operating device or ECG contained in the luminaire or lamp which corrects, compensates or matches the light source or light sources on the basis of characteristics communicated by the recorded data set or data sets.

If, for example, the controller has obtained the information that a first light source at a maximum possible (100%) light current can emit a certain light color and another light source of another lamp can emit the same light color at only a 70% of maximum light current, and it is desired that both lamps uniformly generate light with the maximum possible brightness, the controller can then transmit to the first lamp a signal to ensure that its higher-powered light source will output light at a light current only of 70% of maximum and can transmit to the second, weaker, lamp a signal to operate its light source at maximum light current so that the two lamps will output the same light intensities. In this manner the desired uniform illumination is obtained.

According to an advantageous feature of the invention, the controller uses the data set for correction of the control signal to be transmitted. This means that the characteristics of the particular light source (as downloaded from memory) can be reviewed and especially in the case in which the controller is connected to at least two light sources, the signals thereto will be corrected to match them based upon the characteristics communicated to the controller.

The data set can be stored in another memory, after being downloaded from the memory assigned to the luminaire, for example a memory of the controller. It then is no longer required for the luminaire memory to store the data set and the data set in the memory of the luminaire can be overwritten.

Especially, the readout of the luminaire memory and the transfer of the data set to the controller can occur in the framework of an initialization of the lamp or luminaire network. The controller can be operated with a recognition process in which the luminaires or lamps are provided, for example, with individual addresses and the information as to the types of light sources is obtained and the data sets which involve the characteristics of the light sources are transferred to the controller.

According to an alternative, second, aspect of the invention, the memory or data storage is a part of a separate electronic component which is connected with the operating device. Such a separate electronic component can be connected in series with the operating device and thus can be located between the operating device and the controller. It can receive the control signals from the controller and destined for the operating device and correct them or match then, based upon the data set, and send the corrected or matched control signals to the operating device. The controller need not recognize that such an electronic component is provided which modifies the transmitted control signals.

It is also possible for the electronic component to be connected with a plurality of operating devices and connected to the controller so as to receive control signals destined only for a particular operating device. Upon carrying out a corresponding correction a corresponding pathway is selected so that the control signals, corrected or matched, are transmitted to the respective operating devices. The electronic component can have one or more memories in which the different data sets of different light sources can be recorded. The different light sources, of course, then have respective operating devices assigned thereto.

The electronic component can also differently connect or differently match, for example, the control signals intended only for a certain operating device and obtained from the controller, and transmit the differently matched control signals to the plurality of operating devices. In this manner the electronic component can manage a multiplicity of luminaires in a kind of subsystem within a network of luminaires, e.g. in a DALI network.

According to a further advantageous feature of the invention, the luminaires can each have at least two light sources of different color which are individually addressable by a controller to produce a mixed-color light distribution. A data set is assigned to each light source which describes the characteristics of the respective light source.

This embodiment of the invention enables mixed-color illumination which, for example, can contain a red, a green and a blue component from red, green and blue light sources, respectively, or, alternatively or in addition, a cyan-dyed and/or amber-dyed light source and/or with two or, in total only with two, different white light sources to mix different white tones. In the simplest case of a luminaire containing a red, a green and a blue LED, the light emitted by the LEDs is measured upon manufacture of the lamp and their maximum possible light currents, (lumen outputs) their exact light colors or similar characteristics are stored in the data set of the luminaire memory or the data sets of the luminaire memories.

In the case of a luminaire comprising a red, a green and a blue LED, it is customary to provide a so-called RGB switch power pack, i.e. an operating device in the sense of this disclosure, which can collectively control all three LEDs. This operating device can have an electronic component of the aforedescribed type connected in series with it and this electronic component can be provided with a memory in which the data set describing the characteristic or characteristics of the three different light sources is stored.

If this electronic component receives a control signal from the controller commanding the luminaire to output a certain color, for example a yellow mixed-color tone, the electronic component will match the colors outputted by the three LEDs based upon the stored characteristics of the data set so that the desired color tone is exactly produced.

As has been suggested earlier, a problem which can arise with a luminaire having at least two light sources of different colors is that their exact color values and maximum light currents may differ. For example, a red LED will indeed produce basically red light. The exact light color or color value can vary however within a wavelength range of several nanometers and the specific color value is determined as a rule on fabrication and differences in color value usually cannot be avoided.

With other light sources of other colors, for example, blue LEDS, green LEDs and light sources like OLEDs (organic LEDs) and other light sources, deviations from exact color values and in the maximum lumen output, that is the maximum light current, also can arise.

While deviations of an exact color value for individual light sources generally do not create problems when a monochromatic lamp is to be provided, with lamps or luminaires which are to output a mixed-color illumination, the problem arises that the desired color tone cannot be exactly met. This can be especially a problem when a number of luminaries are directly adjacent one another and intended to generate the identical light colors or color values. In such cases, color deviations in the mixed color outputs can be a particular problem.

It is thus important that a particular color be able to be reproducibly generated with a high degree of color accuracy.

According to the invention, this can be achieved by providing the luminaire with a memory or data storage in which a data set can be registered or recorded, containing information as to the exact color values of the individual light source and/or containing information as to the maximum light currents or lumen outputs of the individual light sources. A correcting device can then be provided which can correct the control signals for those light sources taking into consideration the exact color values and/or the maximum light currents or lumen outputs and the individual light sources can then be controlled with the corrected control signals.

The exact color values and/or the maximum light current or lumen output can be directly recorded in the memory or recorded in the form of a data set or with appropriate coating at manufacture or in the factory. The process by which the data set can be written into memory can include a measuring step, also at the factory, whereby the exact color value and, for example, the exact wavelength emitted by the particular LED and/or its maximum light current or lumen output is measured.

A correcting device can match or correct the control signal in accordance with the data set so that the control of the individual light source can be carried out with the requisite correction. Exact color mixing, i.e. the mixing of precise wavelengths to achieve a desired mixed output color, can be insured so that the desired mixed color value is obtained. An exact color value in the sense of the invention can be a measured color value which takes into consideration the fact that a color designation, like “red” or “blue” is itself imprecise. The exact color value should be a wavelength given in nanometers with a certain degree of measurement precision like, for example, ±1 nm which is a result significantly more accurate than the mere color designation as red or green or blue.

The correcting device can be a part of an electronic component which is preferably incorporated into the lamp or luminaire. The correcting device can automatically process the data set and in this manner generate the information which is considered to provide the exact color value and the maximum light current.

According to a feature of the invention, the correcting device can also form part of an operating device for at least one lamp. Thus an operating device, for example, an electronic switching block for the light source and which optionally can control a plurality of light sources can include an appropriate electronic unit, for example, a microprocessor which can output the correction and thereby undertake a correction of the control signal transmitted to the light source of the lamp automatically. Especially when an operating device has its own controller, can this controller assume the function of the correcting device and carry out the correcting function in a system according to the invention.

In an alternative configuration of the invention, the correcting device is assigned to the controller so that the control signal from the controller through the signal light to the lamp is already corrected at least in part because the correction is here executed in the controller.

In accordance with another aspect of the invention, a lamp or luminaire has a memory or data storage into which is recorded a data set containing information as to the exact color value of the individual light sources of that luminaire and/or information as to the maximum light current or lumen output of the individual light sources of the luminaire, whereby a device for producing a mixed-color light distribution is provided which generates a specific, exact mixed color illumination by controlling the individual light sources taking into consideration the exact color values and/or the maximum light currents.

The invention is based upon the principle that a device for producing a mixed color light distribution can output a predetermined and exact mixed color illumination by controlling the individual light sources of a luminaire containing a plurality of light sources of different colors when the signals controlling the individual light sources takes into consideration the exact color values of the individual light sources and/or their maximum lumen outputs or light currents. The exact color values and the maximum light currents are derived from the values stored in the memory of the luminaire directly or as data sets. The exact color values and/or light currents of the individual light sources, of course, must previously be measured, usually at the factory and the values or data set written into the memory, usually also as factory settings for the individual light sources. The device for producing the mixed color light distribution can refer to multiply data sets or a single data set so that an exact color mixture can be produced. The device can be located in the lamp or luminaire or can be a component or part of a controller connected to the lamp by a signal line.

In the case in which this device is part of the lamp, it is of special advantage to provide the lamp or luminaire directly with the memory in which a data set is stored which has information as to a plurality of exact color mixtures which can be selected. This embodiment of the invention enables the memory to have the various exact color mixture illuminations previously defined therein utilizing the same storage space as used for the data set and containing information as to a multiplicity of exact color mixtures which can be selected. The memory, however, containing the information as to a plurality of color mixtures can be separate from, but associated with the lamp, if desired.

If, in addition to the data sets relating to the individual light sources, the memory of the luminaire contains data sets with respect to a series of factory-set exact color mixtures which can be selected, a setting device of a simple nature, for example, a rotary switch of the color potentiometer type can be used for selecting predesigned output colors each of which can be one of the exact mixed colors of the present invention, i.e. taking into consideration exact and prestored color values and/or light currents or maximum lumen outputs of the individual light sources, previously determined by measurements.

According to another aspect of the invention, based upon the information as to the exact color information and/or the maximum light current of the individual light sources, the control device responsive to that information can signal a color space which can be reached by the lamp or luminaire.

If the exact color values and/or the maximum light currents or lumen output of the light sources of the lamps are determined, that is measured, and the lamp is provided with a memory in which data sets containing information as to the exact color values and/or maximum light currents can be stored, the device can, especially via a signal line which connects the control device with the lamp, read out these values and based thereon provided the further information as to the exact color space in which the lamp is effective.

Since the device knows the exact color values and light current of the individual light sources, it can indicate the color space attainable with the luminaire. The color space attainable by the luminaire is a group of mixed color total light distributions and thus a multiplicity of different colors which can be attained with this lamp or luminaire. while theoretically by mixing light from a red, green and blue light source, practically all colors can be mixed in infinitely fine gradations, in practice, the lamp or luminaire can only reach a portion of all possible colors as determined by the exact color values and the maximum lumen outputs. The color space which is actually attainable is thus always smaller than the theoretically possible color space and is nevertheless an infinitely fine gradation of color mixtures within the attainable color space and is limited by the exact color values and maximum light current. The device can indicate the actually attainable color space, for example, in the form of a normal color table, a color wheel or a color palette of some other diagram which enables the colors to be conveniently displayed. It is significant that a service person or a user receives a display from the device only of the colors which can be actually produced by the device and the lamp so that the indicated colors can be attained (selected or chosen) with a high degree of precision and reproducibility and the colors can be displayed on a screen of the device also exactly and identically to the mixed color distribution which can be produced by the luminaire.

Since the user can see a display directly of the available colors or color mixtures, the selection of the colors for the luminaire is simplified.

According to a further feature of the invention, the device contains information as to color subspaces which represent true parts of the achievable color spaces. In this aspect of the invention, in which color subspaces are provided, i.e. a subspaces can include a subgroup of all of the attainable colors of the lamp, the user can see and select a precise portion of the attainable color space. The subspace can contain specific colors from which the user can make a selection in accordance with certain rules. For example, the subspaces may include only pastel tones or only favorite tones or such mixed colors which may be desirable for a particular purpose, for example a particular corporate entity, or which satisfies particular requirements.

A color subspaces is especially advantageous when certain color tones are desirable for certain applications, for example, shop lighting, lighting to allow true color identification, for example, of garments in a shop and wherever, for example, a product is to be sold or displayed which should not appear differently in normal daylight or the like. Subspaces are also useful where the illumination must simulate particular situations, for example, for cosmetic sales or demonstrations.

The color subspaces can be displayed as a kind of template which is projected on the attainable color space if desired. Such a template can be, for example, a curve or flat region which can be projected onto the entire attainable color space and can be seen to overlap the latter. This enables the lighting planner to immediately determine the relationship of the color subspaces to the attainable color subspaces.

Advantageously, the device can have a memory which can store a group of color subspaces. From this group a service person can select a particular color subspaces. This enables factory set definitions of a number of color subspaces and convenient selection of particular mixed total light distributions by the service person, for example, a light planner, after mounting of the luminaire containing the device and the ability to illuminate specific locations with reproducible and identical color illuminations at different locations of an enterprise.

The invention likewise comprises lamps and luminaires with the features set forth above, taken individually or in any combination, in which the light source is an LED but where other light sources may be used if desired. The lamp or illuminaire will generally have a housing with one or more of such light sources and preferably with the memory.

It has been pointed out that the memory is preferably arranged in the same place or attached to the light source or is otherwise associated therewith. In this case, the memory can be an electronic component which carries the light source or can be an electronic component on a carrier for the light source like, for example, a mounting plate such as a printed circuit board, or a holder such as a base for the LED or light source. Alternatively, the memory can be a data carrier separate from the light source but which normally is attached thereto or packaged therewith at the factory but which can be separated from the light source. For example, the data carrier can be a CD-rom, a RFID (radio frequency identifying tag) or the like sold with the light source.

The memory is preferably an electronic memory which can contain the data set describing the characteristic of the light source. Preferably the data set can be written into the memory as part of a read/write process and may be permanently burned into the memory. The data set can then include at least one characteristic of the light source as has been described, namely, the maximum permissible light current or lumen output or an exact color value, that is an exact indication of the color value emitted by the light source and in operation or its color spectrum. Preferably, however, both are included in the data set assigned to the light source. Alternatively, or in addition, information as to age dependent properties or temperature dependent properties of the light source are written into the memory.

In the case in which the memory is directly coupled with the light source and there is a carrier for both, for example, a circuit board, the memory, for example, after mounting of the light source or the entire component in the lamp, can be read out. The read out can be effected by an electronic component in the lamp or on the lamp and/or by a controller which can be connected to the lamp via a signal line. The readout of the data set enables the lamp or the controller to correct a control signal based upon the stored data set. The light source can thus have a correcting device built into or associated with the lamp or luminaire or connected thereto via the signal line.

According to the invention, the aforedescribed memory for the light source can be the same memory as is associated with a lamp or luminaire, a memory which can replace the memory of the luminaire, or a memory which can be provided in addition to the memory of the luminaire. In the case in which the lamp or luminaire has a memory which is separate from the memory of the light source, it may be advantageous to transfer the memory contents of the light source to the memory of the luminaire. In the case in which the memory of the light source is the memory of the luminaire or completes or replaces it, no further memory may be required.

The light source of the invention can facilitate assembly is of the lamp or luminaire since a measurement of the characteristics of the light source may be omitted upon assembly of the lamp or the luminaire, the measurement having previously been carried out by the manufacturer of the light source. The lamp manufacturer need only read out the memory of the light source and, of course, this can facilitate replacement of a defective light source since one need only consider the information contained in the data set of a replacement light source to insure appropriate connection in and for the lamp.

### BRIEF DESCRIPTION OF THE DRAWING

The above and other objects, features, and advantages will become more readily apparent from the following description, reference being made to the accompanying drawing in which:

FIG. 1 is a schematic block diagram of two lamps connected to a common signal line according to a first embodiment of the invention in which a separate electronic component with a memory is provided;

FIG. 2 is a block diagram further simplified relative to FIG. 1 in which two lamps are connected to a common signal line according to a second embodiment of the invention where the memory is contained in a control unit for a light source;

FIG. 3 is a view similar to FIG. 1 for a system in which three lamps are connected to a common signal line according to a third embodiment of the invention;

FIG. 4 is a block diagram which can be compared to FIG. 2 of a further embodiment of a lamp system according to the invention;

FIG. 5 is a highly diagrammatic view explaining the principles of the invention and demonstrating how the real color space can be achieved using a standard color table;

FIG. 6 is a schematic illustration of the real color space of FIG. 5 together with a possible first subcolor space or color subspace in a sketched form;

FIG. 7 is an illustration according to FIG. 6 showing a second possible subcolor space; and

FIG. 8 is a highly diagrammatic illustration of a lamp according to the invention.

### SPECIFIC DESCRIPTION

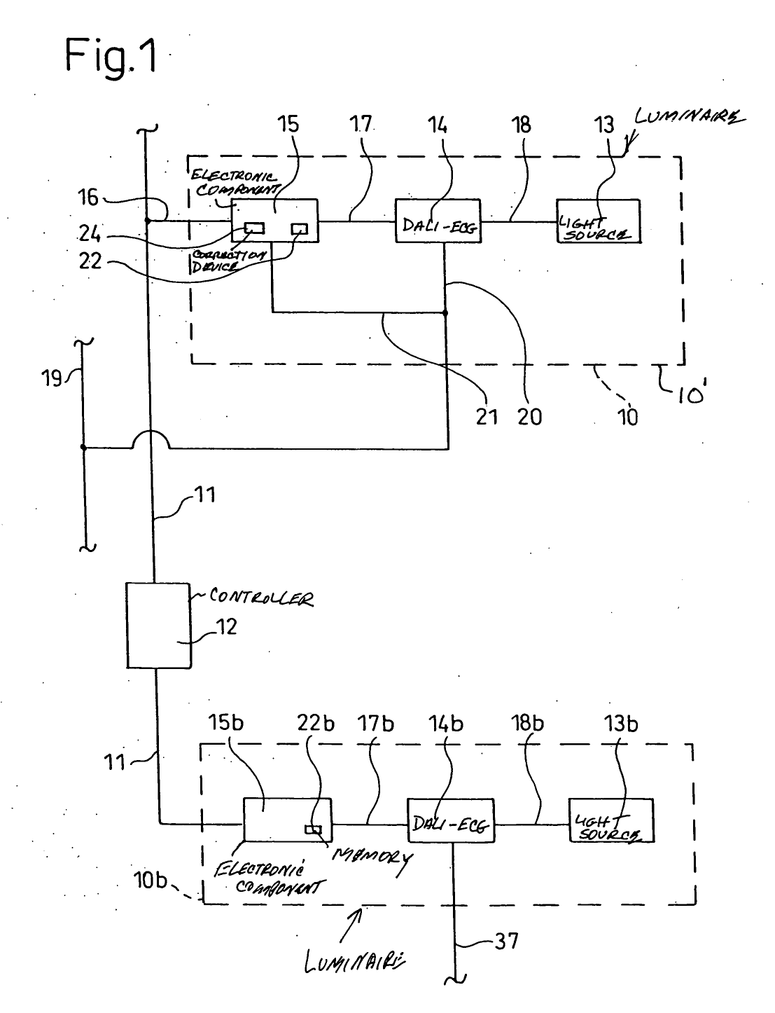

Initially a first embodiment of a lamp according to the invention will be described in connection with FIG. 1. The lamp is indicated as a whole in FIG. 1 with the reference character 10. As a general matter similar structural elements will be indicated in a given Figure or in subsequent Figures of the drawing for any embodiment or part of any embodiment with the same reference numeral followed by a small letter. Similar structural elements can also be represented by the arabic reference character followed by one or more primes.

FIG. 1, for example, shows a signal line 11 to which a first lamp 10 and a second lamp 10b can be connected and which can be for example a two-wire 24 volt control line which can deliver signals in accordance with the DALI protocol. Alternatively, other signal lines or busses may be used optionally, depending upon the signal transmission or communication protocol employed. The protocols used can be, for example, a DMX protocol, TCP/IP protocol or control, the EIB (European Installation bus)-system, LON (local operating network) bus system or protocols or communication systems utilizing the light control busses of any lamp manufacturer.

The signal line 11 is connected with a controller 12 which transmits control signals to the individual lamp, 10, 10b. If desired, the transmission of control information can also be bidirectional over the bus or signal line 11.

The number of lamps of luminaires 10, 10b connected to the controller 12 is dependent upon the control system used and can be, for example, in the DALI Control System, 64 units per controller 12, i.e. 64 subscribers or controlled units. Optionally more than one controller 12 can be provided each with up to the maximum number of subscribers allowed by the control system used.

For simplification in the following description, the invention will be discussed as if it utilized a DALI Control System with a two-wire signal line 11 and a single controller 12 which-emits control signals utilizing the DALI protocol. It will be understood to the reader, however, that other control systems can also be used in combination with a DALI Control System or in place of the DALI Control System.

The lamp or luminaire 10, preferably within a lamp housing represented by the broken line 10′ in FIG. 1, can contain a light source 13, an operating device 14 for switching the light source 13 and an electronic component 15. The signal line 11 connected to the controller 12 has a branch 16 to the separate electronic component 15 which, in turn, is connected by a branch 17 of the control line with the operating device 14 and the operating device 14 is in turn connected by a branch 18 with the light source 13.

In this embodiment, the operating device 14 of FIG. 1 can be a DALI operating device or switching unit, that is a device which satisfies the requirements of the DALI protocol. Such an operating device will be the electronically controlled gear ECG of a DALI system. Naturally, other operating devices which are capable of delivering power to, modulating the power supplied to or terminating power supply to the light source 13 can also be used.

A voltage supply line 19, representing mains voltage, can supply the lamp of luminaire with the operating voltage of 115 or, for example, 230V. FIG. 1 shows only a portion of the voltage supply line 19 which supplies the lamp or luminaire 19, it being understood that the controller 12, the lamp or luminaire 10b and other lamps or luminaires (not shown) can also be connected to the common voltage supply line 19 and that the voltage supply line can carry control signals or the central signals can be transmitted by a wireless mode.

Within the lamp or luminaire 10 itself, the mains voltage can be branched at 20 to the operating device or ECG 14 to supply it with the operating voltage and with the voltage to be switched to the light source 13. The latter can receive the operating voltage through the line 18. If the light source 13 is supplied with the operating voltage in a controlled manner, the light source will illuminate. A further branch 21 from the voltage supply can supply the electronic component 15 with its operating voltage. In an embodiment of the invention which has not been illustrated 1 a voltage supply for the separate electronic component 15 can be provided by the operating device 14 so that the branch 21 can be omitted. Alternatively, it is possible to supply the electronic component 15 with the operating voltage and have the operating device 14 and the light source supplied through the electronic component 15. In this case, it has been found to be advantageous to provide the electronic component 15 with an accumulator (e.g. a rechargeable storage battery or cell) for energy storage.

According to a feature of the invention, the electronic component 15 has a memory 22 which has been illustrated in FIG. 1 only schematically. The memory 22 can be an EEPROM into which can be written a data set which describes a characteristic of the light source 13, especially a measured value of a parameter of the light source 13.

The memory 22, especially, can contain information as to the maximum light current of the light source 13, i.e. the maximum lumen or light-intensity output. Alternatively or in addition, the memory 22 can contain information as to the exact color of the light emitted by the light source 13 and detected in the form of a measured value like the maximum lumen output. Both measured values are recorded in the memory 22 as factory settings upon fabrication of the luminaire 10. This information is then available to the electronic component 15 to serve as a basis for a correction or a matching of the control signals which are received by the electronic component 15 from the controller 12.

It is to be noted that the electronic component 15 is provided upstream of the operating device or ECG 14. The controller 12, which has not been informed that the luminaire 10 is provided with the separate electronic component 15, believes that it is forwarding its control information or control signal directly to the operating device 14.

If, for example, in the memory 22 information is recorded that the light source 13 has a maximum light current or lumen output of 70%, this information can be used for a correction of the control signal which is supplied to the lamp as will be described below. First, however, it can be noted that a second lamp or luminaire 10b in the embodiment of FIG. 1 has the second light source 13b for which for the purposes of discussion only, can be assumed to be of the same color as the light source 13 of luminaire 10. The two light sources 13, 13b, which can be LEDs, can then be assumed to output blue light for the purposes of this example. The light source 13b, however, has a maximum light current or lumen output of 100% and information as to this maximum light current can be registered in the memory 22b of the electronic component 15b of the luminaire 10b.

If the two luminaires 10, 10b receive from their common controller 12, signals to generate a maximum light current of 100%, the light sources 13 and 13b, without correction, would receive identical control commands corresponding to the requested brightness from the two light sources and thus the light sources will be energized to output maximum light current or lumen output.

However, with the invention the electronic component 15 can adjust the control signal based upon the data set in memory 22 indicating that the light source 13 has a maximum light output or light current of 70% which may be the lower limit of a tolerance range for different light outputs and thus can correspond to a minimum usable current. The control signal which appears at the input of the electronic component 15 and in the absence of the invention would be forwarded to the control device 14 uncorrected to cause the light source 13 to generate its maximum light current which is 70% in the case described. If the signal uncorrected was applied to the operating device 14b and the light source 13b, it would operate at 100% and so the light sources 13 and 13b would have different outputs. The result would be a nonuniform illumination of the region provided with the luminaires connected to the controller. With the correction effected based upon the memory contents in the electronic component 15b, that is the memory 22b, however, the light source 13b would be dimmed by a factor of 0.7 to a light current of 70% which is identical to that of the light source 13 (supplied at 100% power).

It is thus apparent that the electronic components 15, 15b or a correction device 24, which can be provided in the electronic component 15, for example, can correct or match the control signals based upon the contact of the data sets in the memories 22 and 22b. Different electronic components 15, 15b can, therefore, recognize that the different light sources 13, 13b have different characteristics and require different connections.

The electronic components 15, 15b can electronically be converters or repeaters which are provided with the correction functions. The data sets remain in the respective memories assigned to the light sources 13, 13b, i.e. are permanently recorded therein so that the data can be downloaded via the control line 11 and supplied to other control circuitry or the luminaires can be disconnected from the signal line 11 and connected to other signal lines of other controllers 12 without losing the information. An important advantage of this embodiment is that the controller 12 need not recognize or know that data sets for correction of the control signals have been provided and thus the lamps or luminaires 10 and 10b of the invention can also be used with other controllers 12 operating with the same protocol, for example, the DALI protocol or with different protocols and different control signals on the signal lines 11 and in spite of these differences, the controller can effectively operate the light sources.

In an alternative configuration of the invention, the controller 12 can read out the memory contents of the memories 22, 22b and the respective data sets can be transferred via the signal line 11. The controller 12 can, consider these data sets and can even process these data sets further to display for the operator the technical characteristics of the lamps connected to the controller.

It is also possible for the central controller, based upon the data sets transferred from the memories 22 and 22b to correct the signals to be transmitted to the lamps 10 and 10b itself. In this case, the electronic components 15, 15b will have the corrections built into them. The electronic components 15 and 15b can be so configured that once the memories 22 and 22b are read by a controller 12, the correcting functions of the electronic components 15, 15b are suppressed or cancelled and these units transmit received signals unaltered to the respective operating device 14, 14b.

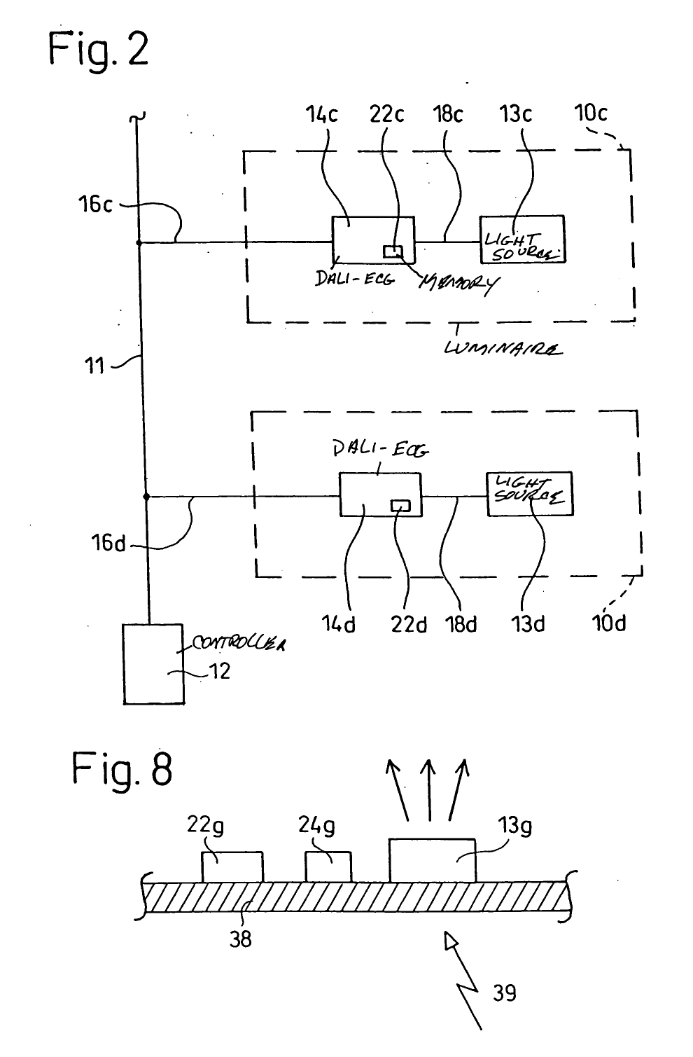

In the aforedescribed embodiment of FIG. 1, it is assumed that the electronic component 15 is a separate element from the operating device 14 contained in the lamp 10. In FIG. 2, an embodiment has been shown in which the memory 22c or 22d need not be provided in the separate electronic component 15.

Rather, FIG. 2 shows in a structure similar to that of FIG. 1, and in block diagram from, a system having two lamps or luminaires 10c and 10d, as with a light source 13c or 13d which can be energized through voltage supply lines 18c and 18d through respective operating devices or switching units 14c or 14d. The respective operating devices are connected via signal line branches 16c and 16d with the signal line and may receive the operating voltage therethrough or from a separate line 19 as shown in FIG. 1. The signal line 11 is connected to the controller 12.

The memories in which the data sets recording the characteristics of the respective light sources 13c and 13d are shown in this embodiment at 22c and 22d to be part of the operating devices 14c and 14d. These may be DALI operating devices which in accordance with the DALI protocol, have light-scene memories. In this case, therefore, the light-scene memories are provided with the data sets describing the characteristics of the light sources 13c and 13d.

By contrast to the system of FIG. 1, in the embodiment of FIG. 1 the correction of the control information does not take place in the lamps 10c or 10d. Instead, upon connection of the lamps 10c or 10d to the signal line 11 of the controller, there is an initialization step of a subsequent method step whereby the memory contents of the memories 22c or 22d are read out and the respective data sets are transferred to the controller 12. Based upon the respective data sets, the controller 12 transmits corrected control information to the individual lamps 10c and 10d to allow as in FIG. 1 the desired target of a given brightness for all of the lamps 10c, 10d, etc. to be reached.

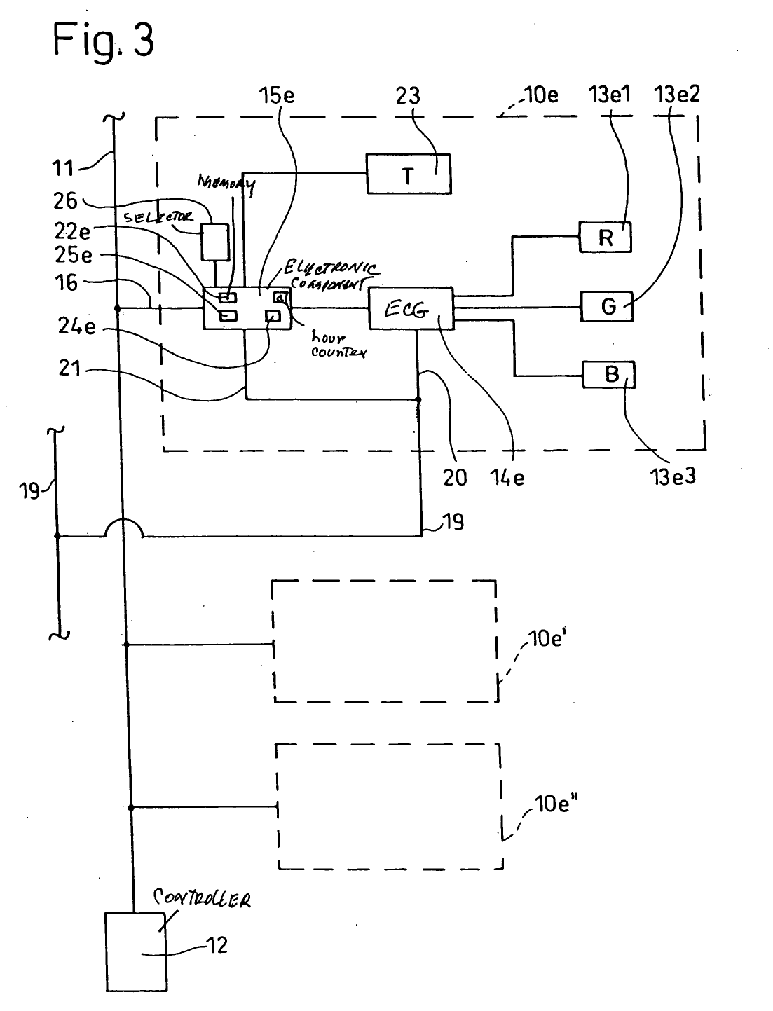

FIG. 3 shows a further embodiment of a lamp or luminaire 10e according to the invention also in a schematic block diagram like that of FIG. 1. In this embodiment, a separate electronic component 15e is provided which includes a memory 22e. The lamp, in addition, includes an operating device 14e, such as a DALI ECG, feeding three different light sources 13e1, 13e2 and 13e3 which can be, for example, a red LED, a green LED and a blue LED.

In that case, the operating device 14e can be a conventional RGB-DALI operating device (RGB-DALI-ECG) for three LEDs. The operating device 14e and the electronic component 15e are supplied with line voltage via the voltage supply line 19 and branches 20 and 21.

The electronic component 15e is analogous to that shown in FIG. 1 and connected via branch 16 with the signal line 11 and thus with the controller 12. Comparable lamps or luminaires 10e′ and 10e″ are likewise connected to the signal line 11.

In the memory 22e of the electronic component 15e one or more data sets are stored which instead of or in addition to the maximum light currents or maximum lumen outputs of the individual light sources 13e1, 13e2, 13e3, also contain the exact color values of the light sources 13e1, 13e2, 13e3 which, for example, in the form of actually emitted wavelengths in nanometers, can have been measured for these light sources. For instance, in the manufacture of the lamp 10e, it can be determined that the blue light source or LED 13e3 has a wavelength LE3, the green light or LED 13e2 a wavelength LE2 and the red light source 13e1, a wavelength LE1.

The red, green and blue light sources of the lamp or luminaire 10e′ which have not been shown in detail in FIG. 3 can, for example, emit different wavelengths which are distinguishable from the wavelengths LE3, LE2 and LE1 as described for the luminaire 10e.

For example, the green color LEDs may have wavelengths varying between 505 nm and 515 nm, a range of values given only as an example. While the green LED 13e1 of the lamp 13e2 may emit green light of the wavelength 515, the corresponding green LED of the lamp 10e′ (not shown) can emit green light of the wavelength 505 nm. The lamp 10e′ and other lamps of the specific subsystem can be connected to the same signal line 11 and, in the case of their green LEDs can have slightly different green values.

Similarly, the red and blue LEDs of the wave lamps can have different color values. In addition, lamps can be provided with light sources of other colors, for example, in addition to the red, green and blue LEDS of certain lamps, a white and/or a yellow LED and/or a cyan-colored LED and/or an LED of amber coloration.

While the color variations are somewhat complex by comparison to systems in which only monochromatic lamps or lighting is desired, utilizing slight color differences in the range of several nanometers as well as slight variations in the maximum lumen outputs or light currents, practically all color mixtures can be obtained with a system of the type shown in FIG. 3.

If the lamps are controlled by a controller 12 through the signal line 11 as shown in FIG. 3, the lamp 10e can emit a mixed color tone of a certain color when the lamp 10e receives a collective signal to the ECG 14e correspondingly controlling the three light sources. If the lamps 10e′ and 10e″ are intended to generate identical colors, these lamps can receive identical control signals from the controller 12.

The memory 22e of the electronic component 15e of the lamp 10e according to FIG. 3 stores a data set according to the invention which describes the exact light color and the maximum light current or lumen outputs of the individual light sources 13e1, 13e2, 13e3. The information can either be information as such directly obtained from the individual light sources or information as to deviations of the light sources from a standard value or, in another alternative, information in the form of a correction factor.

Should the lamp 10e receive, for example, from the controller 12 the signal to produce a certain mixed color, the electronic component 15e, based upon the exact color value and maximum light currents or lumen outputs of the three light sources 13e1, 13e2, 13e3 will correct the control signal obtained and operate the light sources in the corrected manner through the operating device 14e so that the light sources 13e1, 13e2, 13e3 as a consequence of the corrected control inputs, exactly produce the selected light color which has been indicated by the control from the controller 12.

In this manner, in spite of different color values and different maximum light currents and human outputs of the light sources contained in the three lamps 10e, 10e′ and 10e″, the three different lamps can output light of identical colors in practice.

The exact mechanism for the correction using correction matrixes will be described in greater detail hereinafter. At this point however, it can be noted that the lamp 10e of FIG. 3 has an electronic component 15e in which, in addition to the memory 22e, a separate component 24e is arranged which can be termed a correction device or component. This correction device, which can output a corrected value of the control signal from the controller to the operating device or the DALI ECG 14, can be formed as a separate electronic component and can be or can contain a microprocessor. Alternatively, the memory 22e and the correcting device 24e can form a single component in the electronic component 15e or form part of the electronic component 15e.

For the sake of completion, it should also be observed that in FIG. 1 as well, a corresponding correcting device (24) is shown and the artisan will recognize that such a correcting device can be located elsewhere and may be present in the other embodiments as well. What is important is that the correction can be carried out in the electronic component 15e when a control signal is received thereby from the controller 12 via the signal line 11 and is intended for the lamp 10e. For instance, such a signal may indicate that the lamp 10e is only to output red light. The light source 13e1 may not, however, emit the desired red tone of that light because it may have a color value that may vary by several nanometers from the required red tone. The correction can then also allow for a mixing of small amounts of green or blue light from the light sources 13e2 and 13e3 to correct the light outputted by the lamp 10e.

FIG. 3 discloses an embodiment where a separate electronic component 15e operates like the electronic component 15 in the embodiment of FIG. 2. By analogy to FIG. 2, however, the lamps 10e may have light sources 13e1, 13e2 and 13e3 of different colors which have their characteristics recorded in the memory 22e which is then found in the electronic component 14e (compare the memories 22c and 22d in the operating devices 14c and 14d of FIG. 2). Such a modification of FIG. 3 is also within the scope of the present invention. In any case, it is also possible to have the memory 22e read out by the controller 12 so that it can instruct the electronic component 15e to effect a correction function or make the correction itself.

FIG. 3 also shows a sensor 23 to detect a temperature. This temperature can be the ambient temperature of the lamp 10e. Alternatively, a temperature of a chip, namely, the LED chip can be measured. It is also possible to measure different temperatures of the individual light sources 13e1, 13e2 and 13e3.

The ambient or operating temperatures of the individual light sources, especially in the case of LEDs, themselves influence the operation of the LED and the correction applied to the light sources or matching may take into consideration those temperatures. The data set which is then stored in the memory 22e can also describe the temperature dependent properties of the individual light sources 13e1, 13e2, 13e3.

Since frequently the exact operating temperature cannot be detected, the temperature can be measured to a certain approximation, for example, based upon the current traversing the LED or actual usage at particular ambient temperatures and the electronic component 15e can be connected to a device which provides an instantaneous control of the light source 13e1, 13e2, 13e3 based thereon or upon the temperature conditions in the 30 seconds or 60 seconds before then. The instantaneous or ongoing control thus can take into consideration the actual temperatures or temperatures which approximately represent the actual temperatures to correct the control signals optimally for the temperature dependent conditions of the individual light sources. One or more temperature sensors 23 can also be used in the other embodiments disclosed.

Finally, it is also possible to provide an operating hour counter C in the electronic component 15e so that the duration over which the lamp (for example 10e), has been used can be determined. In that case, the memory 22e contains a further data set or information which includes the age-dependency conditions of the individual light sources. The correction effected by the component 15e can be in response, therefore, not only to the temperature dependency of the light source operation but also to the aging dependency thereof and the corrected signal from the controller 12 via the signal line 11 transmitted by the electronic component 15e to the operating device 14e can likewise contain these corrections.

Based upon the knowledge of the temperature dependent properties of the light source and/or the knowledge of the age dependent properties of the light source, over various temperature ranges and/or over very long operating durations or lives a high color accuracy of the luminaires can be insured.

Similarly, in embodiments which have not been illustrated, the data sets can contain the information with respect to temperature and age dependency of the light source, which information can be transferred via the signal line 11 to the controller 12 after having been read out from the respective memory, e.g. memory 22e. A data set as to the temperature or age dependency properties of the light source or light sources can also be provided in the controller 12 originally and, for example, in the framework of an initialization process, the controller 12 can be informed by the lamps, for example, the lamp 10e, which light sources are contained therein so that this aging or temperature dependency information can be used for control signal correction.

FIG. 3 shows that the electronic control element 15e can include a further memory 25e. This memory 25e can receive a mixture data set, namely, information as to exact mixed colors which can be selected. An exact mixed color will be understood to be a light color which can be generated by a plurality of light sources of respective color which when energized with signals to produce respective exact color values and/or the maximum light current or lumen output of the individual light sources 13e1, 13e2, 13e3 will generate a precise mixed color illumination.

By providing a data set containing a multiplicity of such exact mixed colors and storing that data set in a separate memory 25e or an appropriate part of another memory of the system, a selection can be made, for example, via a device 26 shown schematically in FIG. 3, for example, a kind of color potentiometer, to enable one of, for example, 12 selected colors to be outputted. The selector 26 may, of course, be a set of push buttons or some other key pad or push button switching device.

The advantage of a selector 26 for selecting among exact mixed colors is that a plurality of different lamps each with the same mixed data sets can be provided so that the different exact color values and different maximum light currents of the different light sources of the different luminaires can be ignored when the user in the simple manner described via the selector 26, wishes to output identical exact light colors from the multiplicity of luminaires.

Naturally, the memory 25e and the memory 22e can be formed by a common memory. The selector device 26 for the selection of the mixed color can be formed in the same component as the memories 22e and 25e or provided in the same component as the correcting device 24e as a separate element or as part of the electronic component 15e.

The device 26 can be incorporated in the controller 12, if desired, or can be operated by the controller 12 and can be either an electronically triggered or manually operated device which can pass its control signals through the controller 12 or create control signals for exact mixed color selection independently of the controller 12 if desired.

Advantageously, the data sets recorded in the memories 22, 22b, 22c, 22e can contain information as to the maximum light current or lumen output of each light source as well as to the exact color value or color spectrum thereof. Depending upon the type of light source used in the luminaire, it can be sufficient, however, to provide information in the memory of only one of these two characteristics. For example, it may suffice to provide information as to the exact color value when the color values for such light sources vary greatly but the maximum light current or lumen output varies only slightly.

Conversely, when there is a significant variation in the maximum light current or lumen output of the different LEDs but their color values practically do not vary, it may suffice for the memory to have a data set containing only information as to the maximum possible light current.

Finally, for the different light sources, independently of their types, different age dependent and temperature dependent properties can be provided. When these properties strongly effect the light current or the exact color value, the data setting can include such information although the information may be omitted if the aging or temperature dependency of the particular parameter is small for the particular light source.

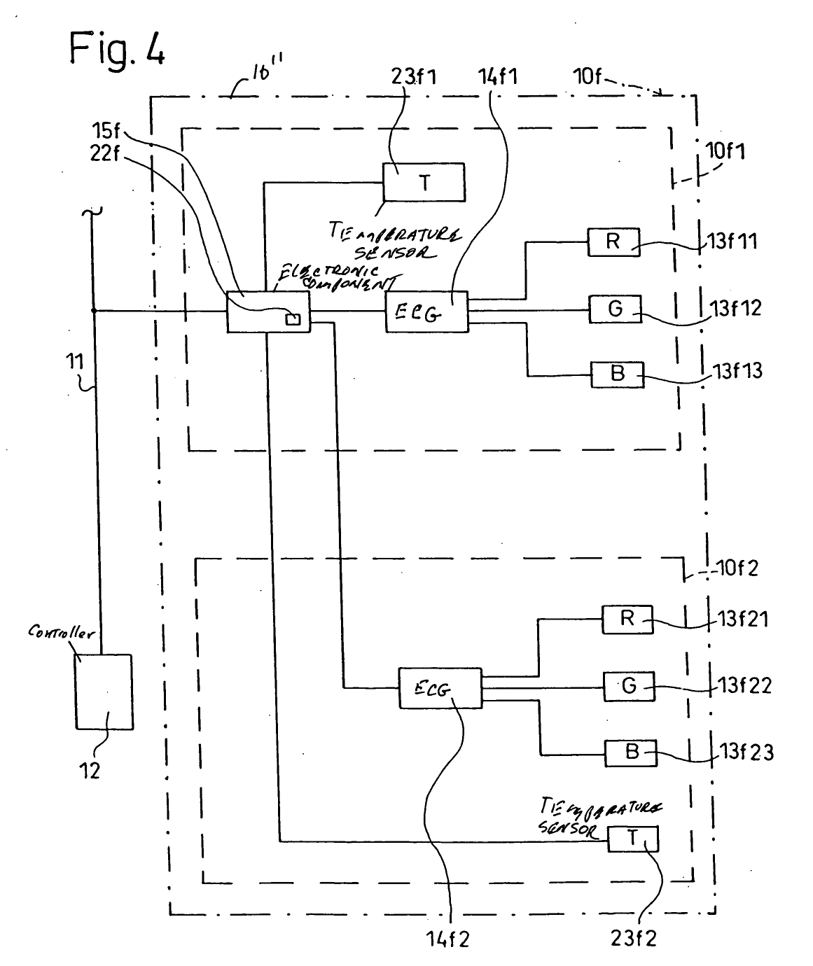

FIG. 4 illustrates a further embodiment of a lamp or luminaire 10f which is described below.

The lamp or luminaire 10f, whose housing is represented by the dot dash line 10″, can be connected to a signal line 11, e.g. a two wire line of a network of such lamps operated by the controller 12. A voltage or power supply line can be provided for the luminaire as has been described in connection with FIG. 2.

The luminaire 10f is comprised of two lamps 10f1 and 10f2 each of which comprises three colored light sources. The lamp 10f1, for example has a red light source 13f11, a green light source 13f12 and a blue light source 13f13. The light sources can be identical to the three light sources 13f21, 13f22, and 13f23 of the second lamp 10f2 and all the light sources can be LEDs.

Each lamp 10f1, 10f2 can contain its own individual operating device or electronic control gear ECG 14f1 and 14f2. The ECGs 14f1 and 14f2 are for example DALI RGB electronic control gears.

A feature of the luminaire 10f is that the two lamps 10f1 and 10f2 can be spaced apart from one another can be spaced apart from one another and even. They nevertheless have a common electronic component 15f which has a memory 22f Recorded in the memory 22f is a data set which contains the characteristics of the different light sources 13f11, 13f12, 13f13, 13f21, 13f22, 13f23 of the lamps 10f1 and 10f2 and in particular exact color values and/or the maximum light currents or lumen outputs of the individual lamps.

The electronic component 15f can have a characteristic DALI address so that it can be addressed by the controller 12. In a unique manner, the electronic component 15f like a conventional DALI operating device or ECG can then be accessed by the controller 12. The electronic component 158, however, is characterized by the fact that it does not simply pass control signals through but rather corrects the control sections fed thereby to the operating devices 14f1 and 14f2 of the two lamps 10f1 and 10f2. The corrections are light source dependent and typically different for the two sets of light sources in the two lamps 10f1 and 10f2.

If the electronic component 15f illustrated receives a control signal from the controller 12, for example, which is to generate a certain light color, then based upon the individual corrections and matching of the actual measured color value and/or light current maximum of the individual light sources of the two lamps, corrected control signals are transmitted to the operating devices so that the two lamps 10f1 and 10f2 will generate actually exactly the same light colors.

The electronic component 15f can, of course, address also a greater number of operating devices 14f1, 14f2 to manage them so that at the output side of the electronic component 15f, practically a subsystem of a DALI network can be connected. Since the electronic component 15f of the DALI network has only one address, a very large number of lamps can be managed rather than a limit of 64 subscribers to which the usual DALI network would be restricted in the absence of the intermediate electronic component 15f.

Such an arrangement using the electronic component 15f can save addresses in an overall DALI network and can nevertheless service a large number of operating devices 14f1 and 14f2. The component 15f serves in addition to be sure that the lamps 10f1 and 10f2 will output the identical colors.

FIG. 4 shows, in addition, that the electronic component 15f can be equipped with two or more temperature sensors 23f1, 23f2. The temperature sensors measure the different ambient or local temperatures (operating temperatures of the lamps) to provide a correction for temperature-dependent properties of the individual light sources in the afore-described manner.

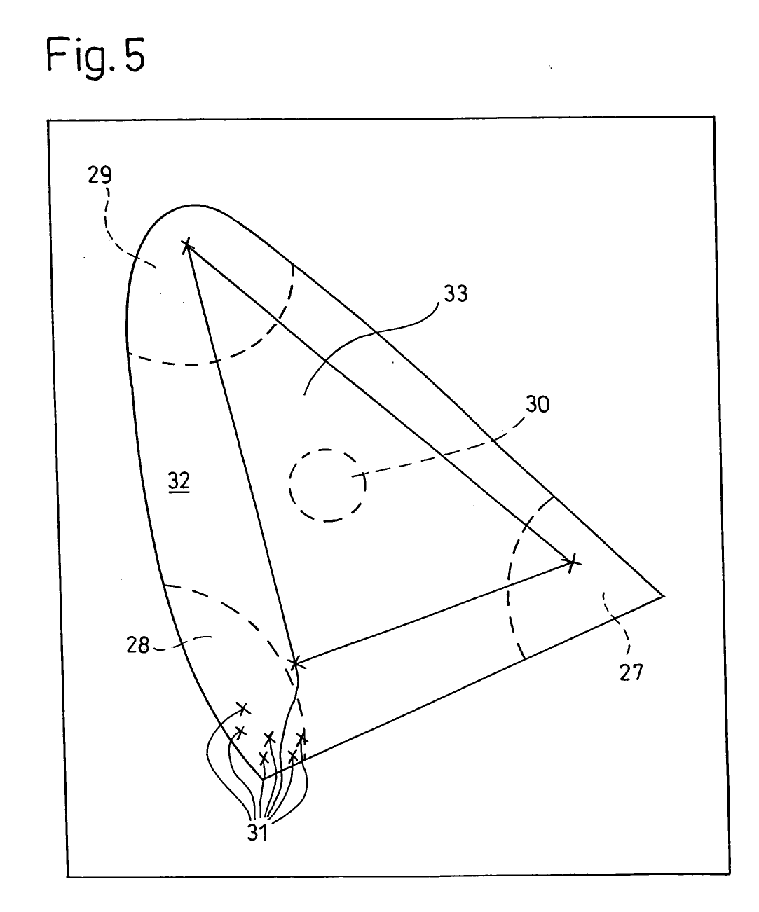

FIG. 5 shows a standard color table as is known in the field of light technology and is of the type found, for example, in the Lange Handbook for Illumination, published by the German Light Technology Company, 4^{th} Edition, 1996, page 16. From this reference and general principles in light technology, it is understood that the standard color table is a substantially triangular surface with a right hand region 27 to which the red color is assigned, a lower left region 28 to which a blue color is assigned and an upper edge region 29 to which the green color is assigned. A central region 30 is the region of substantially white light. The intermediate regions represent mixed colors obtained by mixing of the individual primary colors. The standard color table shows theoretically all possible colors which can be outputted by an ideal lamp with three ideal light sources, namely a true blue light source, for example a blue LED of a lamp as described. The other two light sources are a true red LED and a true green LED.

A blue LED emits an exact color value which is unique only for that particular light source and can differ from the exact color values of other blue LEDs. The crosses indicated at 31 in the region 28 of FIG. 5 represent a group of measurement points for the color values of blue LEDs produced by an LED manufacturer and supplied to the lamp maker.

Since these measured values lie at different locations in the color triangle of the standard color table, by mixture of the blue light with the light from a red or green LED in the same luminaire different color tones can result and the color field may not cover the entire color space of the color table as represented by the area 32 but rather for example, only a limited color space 33 as represented by the triangle in FIG. 5.

The attainable color space is therefore significantly limited with respect to the theoretically possible color space. This attainable color space is different for each lamp based upon the different color values of the individual light sources and represents the totality of the mixed color illuminations which can be actually outputted by the luminaire.

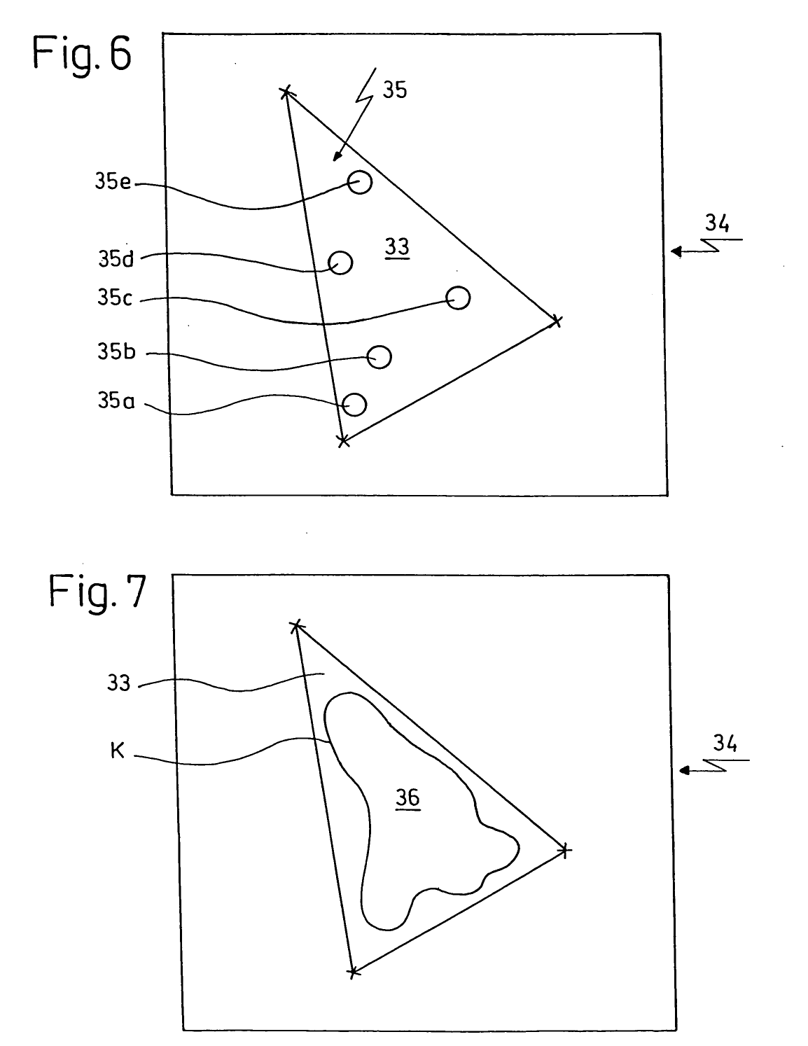

The control device 12 can be provided to manage a multiplicity of lamps 10e according to FIG. 3 or other lamps or luminaires and can have a display device which in FIGS. 6 and 7 has been indicated as a whole at 34. FIGS. 6 and 7 show only the content of the display in this. The display which is selected is a display like that of a standard color table although other color space displays can be provided, for example a color wheel, color pallette or the like.

FIG. 6 shows that the display device, for example a computer screen, can show the actually attainable color space 33 of the respective lamps. For the case in which a multiplicity of different luminaires are managed by the controller 12, the display can cover any number or group intended to operate together. In FIG. 6 the display which is monitored by the service person shows a triangle of the mixed color illuminations which can actually be produced by the managed or controlled lamps or luminaires.

In addition to this triangular display, FIG. 6 shows five circles 35a, 35b, 35c, 35d, 35e which are projected, like a kind of template on the actually attainable color space 33. The five discrete mutually spaced circles form in total a subcolor space or color subspace 35 which represents a true portion of the attainable color space 33.

FIG. 7 show in an illustration which can be compared with FIG. 6 the actual attainable color space 33 and another subcolor space 36 which differs from the subcolor space 35 according to FIG. 6. The subcolor space 36 has been shown basically as a closed flat region with a predetermined contour K which also forms a true part of the actually attainable color space 33. This subcolor space 36 is likewise projected like a template on the actually attainable color space 33.

A service person monitoring the display can select a desired subcolor space from among a plurality of subcolor spaces (for example 35 and 36) which have been stored in the memory of the controller 12. The person monitoring the system thus can easily produce mixed color illumination which can be exactly reproduced from predetermined available illumination information stored in memory in the form of the actually attainable color spaces, the particular subcolor space which can be projected on the actually attainable color space and the specific mixed color illumination from the subcolor space.

In all embodiments a super control line 37 can be provided as for example has been illustrated in FIG. 1 which can bypass the electronic control element 15b and cause the respective operating device (e.g. 14b) to operate without correction. Such an override or direct operation can be desired for example when a user wishes to generate the maximum possible light current or lumen output from the luminaire top independently of the color to be produced or for the case in which compensation or correction may not be desired.

The lamps or luminaires of the invention to the extent that they offer electronic components 15 which are separately provided with a memory and especially are intended to have a correcting function, can function as converters of the type in which especially DALI control signals control signals can be converted into corrected DALI control signals for a downstream operating device. Alternatively, they may participate in other conversions, for example, in protocol translation like a kind of gateway, for example, from DMX to DALI or from DALI to DMX, or from DALI to pulse width modulated signals or from DALI to a LON bus or an EIB bus or vice versa.

These conversion functions are preferably directly integrated into the separately provided components 15a, 15b, 15c, 15d, 15e, 15f.

The way in which the electronic component 15e of a luminaire 10e according to FIG. 3 and particularly the way in which the correcting device 24e of the electronic component 15e of the lamp effects a correction of the control signal received from the controller 12 is described in greater detail below.

The signal transmitted by the controller 12 and received by the electronic component 15e can have for example the form of a current vector of the type:

$$I = ( \begin{matrix}Ir \\ Ig \\ Ib\end{matrix} )$$

whereby the individual components Ir, Ig and Ib are respectively the current components which are to be sent to the three light sources 13e1, 13e2 and 13e3. The current component Ir of the light current refers to the light current of the red light source 13e1. It should be clear that the current components Ir, Ig and Ib can each lie between 0 and 100% and when the DALI protocol is used each of the three values Ir, Ig and Ib can be defined with 8 bits so that 256 different gradual subdivisions will be possible.

The current vector I with the current components Ir, Ig and Ib is supplied as an input signal or input to the electronic component 15e. From the electronic component an output signal (output) is transmitted to the respective operating device 14e which is also a vector and of the form

$$O = ( \begin{matrix}Or \\ Og \\ Ob\end{matrix} )$$

whereby the three variables Or, Og and Ob each represent a light current which will be actually emitted by the three light sources 13e1, 13e2 and 13e3 after the correction has been carried out. The variable Or represents the light current emitted by the red light source 13e1. Furthermore, the values Or, Og and Ob lie between 0 and 100% and, in the case of an eight bit resolution, encompasses 256 light current values.

The electronic component 15e automatically carries out a correction of the input signal I to the output signal O and the correction can be of the form O=K*I where K is a matrix. The matrix can be or is representative of the aforementioned data set and includes information as to the characteristics of the light source. The matrix is of the form, for example:

$$K = ( \begin{matrix}rr & rg & rb \\ gr & gg & gb \\ br & bg & bb\end{matrix} )$$

The matrix has nine entries for which the following typical values can be given:

The values for rr, gg and bb are ≧70% and ≦100% with light sources like colored LEDs. Similarly, the values rg, rb, gr, gb, br and bg are ≧0% and ≦5%.

Furthermore, the minimum output (e.g. 70%)<(rr+rg+rb≦100%.

The minimum output is for example the conceivably smallest maximum light current of a light source. For clarification it may be assumed that the input signal has the form

$$I = ( \begin{matrix}1 \\ 0 \\ 0\end{matrix} ) .$$

This means that the signal transmitted by the controller 12 is intended only to control the red light source 13e1.

Since the red light source 13e1 has an exact color value, a so-called actual color value, from which a set point color value may deviate (i.e. deviating from an ideal red by several nanometers), it may be necessary to mix small amounts of green or blue light from the light sources 13e2 and 13e3 therewith so as to achieve the desired redness that is the desired mixed colored illumination and overall light distribution.

The output can then be determined in accordance with the formula

$$O = I * K = ( \begin{matrix}I \\ O \\ O\end{matrix} ) * K$$

from which it is clear that in the case in which the variables gr and br will deviate from 0, the output vector would correspond to

$$O = ( \begin{matrix}rr \\ gr \\ br\end{matrix} )$$

Which represents the control signal which is outputted to the operating device 14e and also contains green and blue light components when gr and br are not equal to 0.

From the foregoing it will be apparent that the variables gr and br give additional light components which are to be mixed with the light from the red light source or LED 13e1 to produce a certain predefined exact red tone or coloration.

Stated otherwise, the electronic component 15e which is to ensure that an exact color value of the red light source 13e is produced can take into consideration an actual value which deviates from a set point value of the red light source 13e1. The correcting device or circuit 24e of the electronic component 15e or that component itself, through the use of the correcting matrix K can effect the desired correction and produce an exact mixed coloration. The matrix K as described has nine constants which each typically require one byte, i.e. eight bits. The correcting matrixes can be more complicated when color differences, maximum possible light color differences or maximum lumen outputs and their temperature dependencies must be considered. In this case, the output O is determined from the temperature dependent correction matrix K(T) and the input signal I in accordance with the formula O=K (T)*I, whereby

$$K ( T = ( \begin{matrix}rr ( Tr ) & rg ( Tg ) & rb ( Tb ) \\ gr ( Tr ) & gg ( Tg ) & gb ( Tb ) \\ br ( Tr ) & bg ( Tg ) & bb ( Tb )\end{matrix} )$$

This matrix has nine matrix terms which are temperature dependent and it assumes that the temperature dependencies of the values are known at least approximately or have been determined at least approximately by measurement.

The temperature term Tr is, for example, the temperature of the red light source, the temperature Tg is the temperature of the green light source and the temperature Tb is the temperature of the blue light source. Generally it suffices to measure a single ambient temperature, for example, the circuit board temperature and thereby provide a single temperature measurement value M. Knowing the channel outputs O and the temperature measurement value M, the actual temperatures of the individual light sources (red, green, blue) can be deduced.

Finally, the correcting matrix X can include a correction factor which takes into consideration the dependency of the light generation by the individual light sources. In that case a correction matrix with the age dependencies can be provided in the form of

$$K ( A ) = ( \begin{matrix}rr ( Ar ) & rg ( Ag ) & rb ( Ab ) \\ gr ( Ar ) & gg ( Ag ) & gb ( Ab ) \\ br ( Ar ) & bg ( Ag ) & bb ( Ab )\end{matrix} )$$

whereby O=K(A)*I.

The values Ar, Ag and Ab, that is the aging of the light sources are determined by integrating the associated light source dependent output signals over time. There can be an intermediate storage of the individual outputs integrated over time.

To permit both color and light current differences and the temperature and aging characteristics to be taken into consideration, finally, the correcting matrix which is used and stored in memory can be of the form

$$K ( T , A ) = ( \begin{matrix}rr ( Tr , Ar ) & rg ( Tr , Ar ) & rb ( Tr , Ar ) \\ gr ( Tg , Ag ) & gg ( Tg , Ag ) & gb ( Tg , Ag ) \\ br ( Tb , Ab ) & bg ( Tb , Ab ) & bb ( Tb , Ab )\end{matrix} )$$

Preferably the correcting device 24e utilizes the latter correcting matrix and multiplies the input vector I in the form of the controlling signal received from the controller 12 by the matrix K(TA) to produce the output signal which is transmitted to the operating device 14e.

As has previously been described, the matrix can be utilized directly in the controller 12 when, for example, the matrix value K is not a temperature and/or age dependent matrix and is downloaded from the memory of the lamp to the controller.

Alternatively only a part of a stored correction matrix, for example the age dependent part or the temperature dependent part can be used or the correction carried out only with respect to the color value or the maximum lumen output.

FIG. 8 shows in a schematic and broken away partial section from the side an embodiment in which the light source 13g, for example, an LED, is a surface mounted diode SMD. The SMD-LED 13g is here fixed on a printed circuit board 38 on which is provided a memory 22g in which a data set assigned to the LED 13g is stored. This data set can be one of the correcting matrixes which have been described and which can include characteristics of the light source 13g. The light emitted from the LED 13g has been symbolized by the arrows spreading therefrom.

It will be apparent that the light 13g together with the circuit board 38 and its memory 22g form a unit which can be mounted as such in the lamp. The memory 22g can be connected via conductor tracks of the board 38 electrically with the LED 13g. In this case, the memory 22g, which typically is an electrical component and which may preferably contain a microprocessor, can also serve as a control unit for the light source 13g.

The light source 13g can be a monochromatic LED or can represent a number of LEDs with different colors.

When the memory 22g is electrically connected with the light source 13b on the circuit board it suffices to connect the entire unit representing at 39 in FIG. 8 with a pair of conductors in the system of FIG. 1.

For the case in which the memory 22g is not electrically connected with the light source 13g, separate communications, plugs or contacts are provided on the unit 39 to enable the memory 22g and separately therefrom, the light source 13g to be connected to the other elements in the lamp 10.

In the memory 22g, in the aforedescribed manner and as described with respect to the embodiment of FIGS. 1 to 4 or in a similar way, a data set is recorded which enables a correction of the control signals to the light source 13g. A distinction over earlier light sources is that the light source 13g, usually a single diode but possibly a number of diodes of different colors, is specifically associated with the memory 22g whose data set specifically contains the critical information with respect to the light source.

The contents of the memory 22g can be either read out so that the correcting function can be handled by a correcting device which can be provided in the lamp separate from the unit 39 or such that the memory can carry out the correction itself. When a readout is involved the controller 12 can assume the correcting function. It is also possible in the embodiment illustrated in FIG. 8 to provide a correcting device 24g on the circuit board 38 and as part of the unit 39 to correct the signal supplied to the light source 13g. The correcting device 24g and the memory 22g can have respective microprocessors and ee prom storage, can be a single electronic component with a microprocessor and EEPROM storage or may be respectively a microprocessor and an EEPROM memory.

The memory 22g which is assigned to the light source 13g s can also be made structurally independent from the light source 13g and from the component 39 and can be in the form of a data carrier, for example a CD ROM or an SD card which is packaged with and sold with or supplied with the light source 13g or the component 39 in this case, the light source 13g and the memory 22g are provided or supplied in a unit which prevents the memory 22g and the light source 13g from being separated until the light source is incorporated into the lamp. This enables a decentralized read out of the contents of the memory when for example the light source 13g is put into the lamp 10 and the memory read out to the controller 12 separately from the connection of the light source to the lamp.

When the memory 22g and the light source 13g are separate from one another, it is possible to provide a component of the lamp which can read out the memory 22g when the lamp is mounted in the lamp or the mounting is complete.

While FIG. 8 shows an LED as the light source, other light sources can be provided with comparable memories 22g, for example the memory can be provided in a lamp socket or carrier for another type of clamp and it the lamp forms a unit with some other kind of operating device the memory 22g can also be arranged thereon. The data set can be recorded in the memory 22g when the light source 13g or the unit 39 are fabricated and the factory recordal of the data set ensures that it will be preferably applied by the manufacturer.

The invention is deemed to include all of the features of novelty described here individually and in every possible combination and each in combination with all of the various embodiments described.

I claim:

1. A lamp comprising at least one light source controllably addressable through a signal line; and a memory containing a data set describing at least one characteristic of said light source.

2. The lamp defined in claim 1 wherein the data set contains a measured value of a parameter of said light source.

3. The lamp defined in claim 2 wherein the data set includes information as to a maximum measured light current of said light source.

4. The lamp defined in claim 3 wherein the data set includes information as to an exact light color and/o wavelength and/or spectrum of said light source.

5. The lamp defined in claim 2 wherein said data set includes information as to a temperature dependent property of said light source.

6. The lamp defined in claim 5, further comprising a sensor for detecting a temperature affecting the operation of said light source.

7. The lamp defined in claim 2 wherein said data set includes information as to an aging-dependent characteristic of the light source.

8. The lamp defined in claim 7 wherein said memory is connected with a device for detecting an operating duration of the light source.

9. The lamp defined in claim 2 wherein said data set is written into the memory upon manufacture.

10. The lamp defined in claim 2, further comprising a controller is connected with said signal line.

11. The lamp defined in claim 10 wherein said lamp is connected to a current supply line.

12. The lamp defined in claim 10 wherein said controller communicates with the lamp with control signals in accordance with the DALI protocol.

13. The lamp defined in claim 10 wherein the lamp is provided with a DALI electronic control unit addressable by said controller.

14. The lamp defined in claim 13 wherein said electronic control unit is connected with the voltage supply line and the signal line.

15. The lamp defined in claim 14 wherein said light source is connected with the electronic control unit.

16. The lamp defined in claim 15 wherein said memory is located in said electronic control unit.

17. The lamp defined in claim 16 wherein said memory is readable by the controller.

18. The lamp defined in claim 17 wherein the data set is transmissible over the control line.

19. The lamp defined in claim 18 wherein the controller transmits control signals to said lamp upon reset of the data set based upon properties of said light source.

20. The lamp defined in claim 10 wherein the controller uses the data set for a correction to control signals transmitted by said controller.

21. The lamp defined in claim 20 wherein the memory can be overwritten upon readout of said data set.

22. The lamp defined in claim 16 wherein the memory is a light scene memory of a DALI electronic control device.

23. The lamp defined in claim 15 wherein said memory is a component of a separate electronic circuit element which is connected with the electronic control device and the signal line.

24. The lamp defined in claim 23 wherein the component is located in a housing of the lamp.

25. The lamp defined in claim 24 wherein said component is connected ahead of the electric control device.

26. The lamp defined in claim 25 wherein the component corrects or matches control signals received from the controller based upon the data set and transmits the corrected or matched control signals to the electronic control device.

27. The lamp defined in claim 12 which has at least two light sources of different colors individually addressable by said controller for producing a mixed color illumination.

28. The lamp defined in claim 27 wherein the data set written into the memory includes at least one characteristic of each of the at least two light sources.

29. The lamp defined in claim 26 wherein said component is connected with a plurality of said electronic control devices.

30. The lamp defined in claim 29 wherein said memory includes different data sets containing characteristics of different light sources.

31. The lamp defined in claim 30 wherein the component corrects or matches control signals received from the controller based upon the different data sets and the corrected control signals are transmitted to the plurality of electronic control devices.

32. A lamp having at least two light sources of different colors, especially at least one red at least one green and at least one blue light source, addressable with control signals supplied to the lamp through a signal line from a controller, the lamp having a memory containing a data set with information as to an exact color value of the individual light sources and/or containing information as to maximum light currents of the individual light sources, whereby a correction device is provided which corrects the control signals based upon the exact color values and/or the maximum light currents and operates the individual light sources with corrected control signals.

33. The lamp according to claim 32 characterized in that the correction device is associated with the lamp as a component thereof.

34. The lamp according to claim 33 wherein the correction device is a component of the electronic control element of the lamp.

35. The lamp defined in claim 32 wherein the correction device is a component of an electronic control device of at least one lamp.

36. The lamp defined in claim 32 wherein the correction device is located in the controller.

37. A lamp having at least two differently colored light sources and especially at least one red, at least one green and at least one blue light source individually addressable by control signals, the lamp having a memory in which a data set containing information as to an exact color value of each individual light source is maintained and/or containing information as to maximum light currents for the individual light sources, whereby a device for producing color mixed light patterns is provided in which specific exact color mixing is effected by controlled operation of the individual light sources taking into consideration the exact color values and/or maximum light currents.

38. The lamp defined in claim 37 wherein the lamp has a memory in which a mixed data set with information as to a plurality of colors to be mixed can be stored.

39. The lamp according to claim 38 which is provided with a device for adjusting the exact colors to be mixed based upon the mixed data set.

40. A device for controlling at least one lamp having at least two differently colored light sources, especially at least one red, at least one green and at least one blue light source, for generating a mixed color illumination from the lamp and wherein the light sources are individually addressable, said device responding to information as to exact color values and/or maximum light currents of the individual light sources for signalling a color space attainable by the lamp.

41. The device according to claim 40 wherein the device contains information as to a subcolor space which can represent a true partial quantity of the attainable color space.

42. The device according to claim 41 wherein the device indicates a subcolor space.

43. The device according to claim 42 wherein the subcolor space is projected on the attainable color space as a kind of template.

44. The device according to claim 43 wherein the device comprises a memory which encompasses a group of several subcolor spaces.

45. The device according to claim 44 wherein the device enables a selection of a subcolor space from the group.

46. A light source for a lamp which has a memory associated with it into which a data set can be registered.

47. The light source defined in claim 46 wherein the data set describes a characteristic of the light source.

48. The light source according to claim 47 wherein the data set contains information as to a maximum measured light current of the light source.

49. The light source defined in claim 48 wherein the data set includes information as to an exact measured light color and a wavelength and an exact spectrum as measured of the light source.

50. The light source defined in claim 49 wherein the data set includes information with respect to a temperature dependent property of the light source.

51. The light source defined in claim 50 wherein the data set includes information as to an aging property of the light source.

52. The light source according to claim 51 in which the data set is inscribed in the memory as a factory setting upon manufacture.

53. A light source according to claim 52 wherein the light source upon mounting in a lamp is directly or indirectly addressable by a controller via a signal line.

54. The light source according to claim 53 wherein the memory is readable by a component of the lamp and/or by the controller.

55. The light source according to claim 54 which is formed by an LED affixed to a circuit board, mounting plate or light fixture and the memory is provided on a circuit board, mounting plate or light fixture.

56. The light source according to claim 55 wherein a correcting unit is provided which corrects control signals received by the light source based upon the data set including an exact color value of the light source and/or a maximum light current thereof and controls the light source with the corrected control signals.

57. The light source according to claim 56 wherein after mounting of the light source in or on the lamp the data set is transmitted to another electronic component of the lamp.

58. A method of operating a lamp comprising the steps of:
(a) providing at least one light source in a lamp housing;
(b) at a time of manufacture storing in a memory assigned to the lamp at least one data set including information specific to the light source, said information comprising of at least one item selected from the group which consists of:
(i) an exact color value of the light source,
(ii) a maximum light current of the light source,
(iii) an aging-dependent property of the light source,
(iv) a temperature-dependent property of the light source,
(v) the wavelength of the light source, and
(vi) a spectrum of the light source;
(c) downloading said data set to a controller; and
(d) addressing said light source selectively through a control line connected to said lamp with signals corrected with reference to said data set downloaded from said memory.

59. The method defined in claim 58 wherein said memory and said controller are provided in a relationship to the lamp selected from:
i) said memory and said controller are both located in the lamp;
ii) said memory is lcoated into the lamp and said controller is located in a central control system connected to the lamp by said line; and
iii) said memory is a data carrier separable from said lamp and marketed therewith and said controller is located in a central control system connected to the lamp by said line or is in said lamp.

60. The method defined in claim 59, further comprising the step of measuring at least one item of said group for the light source of said lamp.
